(19) United States
(12) Patent Application Publication
(10) Pub. No.: US 2014/0178115 A1
(43) Pub. Date: Jun. 26, 2014

(54) TRANSPORT DEVICE AND IMAGE FORMING APPARATUS

(71) Applicant: FUJI XEROX CO., LTD., Tokyo (JP)

(72) Inventors: Yuichi Fujisawa, Kanagawa (JP); Akihiro Ouchi, Kanagawa (JP); Hiroaki Yagi, Kanagawa (JP); Arichika Tanaka, Kanagawa (JP); Koichi Sato, Kanagawa (JP); Kazuyuki Yagata, Kanagawa (JP); Koji Deguchi, Kanagawa (JP); Hibiki Sasaki, Kanagawa (JP); Kaoru Matsushita, Kanagawa (JP)

(21) Appl. No.: 13/923,553

(22) Filed: Jun. 21, 2013

(30) Foreign Application Priority Data
Dec. 21, 2012 (JP) 2012-278858

(51) Int. Cl. G03G 15/00

(52) U.S. Cl. CPC G03G 15/6529
USPC 399/381; 271/264

(57) ABSTRACT

A transport device includes an endless belt having a recording-medium transport surface provided with multiple holes; stretching members between which the endless belt is stretched so as to be able to revolve; and a suction unit provided inside the endless belt. The suction unit has an opening having a larger width than the endless belt. The opening is exposed at both sides of the endless belt in the width direction. The suction unit draws air through the opening to cause the recording medium to stick to the endless belt.

### CROSS-REFERENCE TO RELATED APPLICATIONS

This application is based on and claims priority under 35 USC 119 from Japanese Patent Application No. 2012-278858 filed Dec. 21, 2012.

### Background

(i) Technical Field

The present invention relates to transport devices and image forming apparatuses.

(ii) Related Art

An image forming apparatus, such as a copier or a printer, includes a transfer unit that transfers a toner image formed on a photosensitive member to a recording medium, and a fixing unit that fixes the toner image transferred to the recording medium. This image forming apparatus uses a transport device to transport the recording medium from the transfer unit to the fixing unit.

### SUMMARY

According to an aspect of the invention, there is provided a transport device including an endless belt having a recording-medium transport surface provided with multiple holes; stretching members between which the endless belt is stretched so as to be able to revolve; and a suction unit provided inside the endless belt. The suction unit has an opening having a larger width than the endless belt. The opening is exposed at both sides of the endless belt in the width direction. The suction unit draws air through the opening to cause the recording medium to stick to the endless belt.

### BRIEF DESCRIPTION OF THE DRAWINGS

Exemplary embodiments of the present invention will be described in detail based on the following figures, wherein:

FIG. 1 schematically illustrates the configuration of an image forming apparatus according to an exemplary embodiment;

FIGS. 2A to 2C are, respectively, a schematic perspective view, a schematic plan view, and a schematic cross-sectional view of a transport device according to the exemplary embodiment;

FIGS. 3A and 3B are schematic plan views of the transport device according to the exemplary embodiment;

FIG. 4 is a schematic view of an opening according to the exemplary embodiment; and

FIG. 5 is a graph of the load on a driving unit for the transport device.

### DETAILED DESCRIPTION

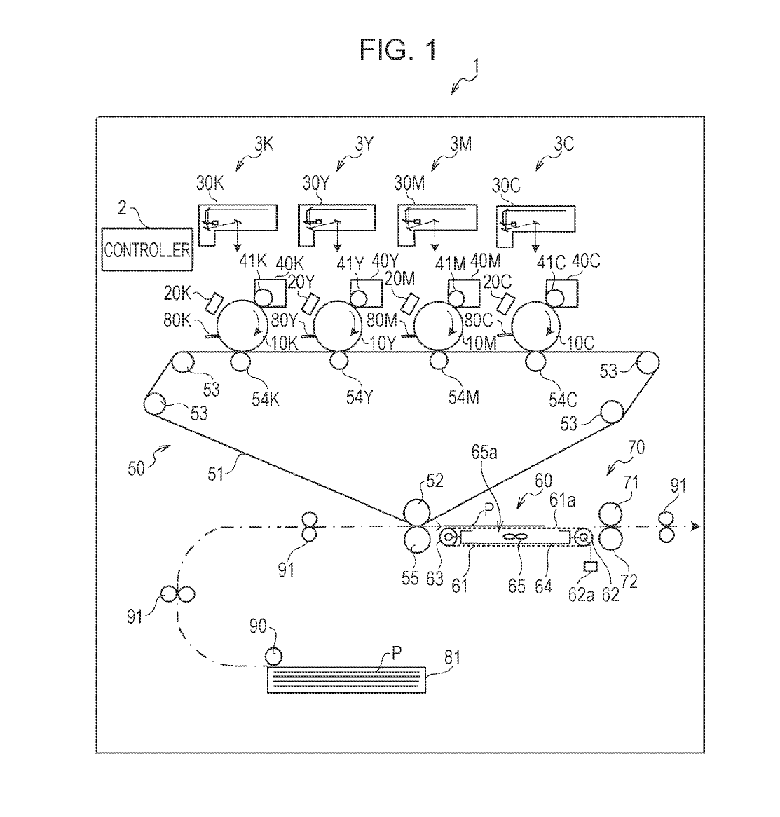

An exemplary embodiment of the present invention will be described below with reference to the drawings. FIG. 1 schematically illustrates the configuration of an image forming apparatus according to the exemplary embodiment. An image forming apparatus 1 according to the exemplary embodiment includes a controller 2, image forming units 3K, 3Y, 3M, and 3C, a transfer unit 50, a transport device 60, a fixing unit 70, and a sheet storage unit 81. The image forming apparatus 1 forms an image on a recording medium, such as a sheet P, according to image information transmitted thereto.

The image forming units 3K to 3Y form toner images of black (K), yellow (Y), magenta (M), and cyan (C). As illustrated in FIG. 1, each of the image forming units 3K to 3C includes a corresponding one of photosensitive members 10K to 10C, a corresponding one of charging units 20K to 20C, a corresponding one of exposure units 30K to 30C, a corresponding one of developing units 40K to 40C, and a corresponding one of cleaning units 80K to 80C. These components will be collectively called when they don't need to be distinguished (e.g., the image forming units 3K to 3C will be simply called the “image forming unit 3”).

The controller 2 includes a calculation device, such as a central processing unit (CPU), and a memory. The controller 2 controls the operation of components of the image forming apparatus 1.

The photosensitive member 10 (10K to 10C) is a cylindrical member having an image-bearing photosensitive layer formed of an organic photosensitive material. The photosensitive member 10 rotates in the direction indicated by the arrow in FIG. 1.

The charging unit 20 (20K to 20C) applies a predetermined charging voltage to the surface of the photosensitive member 10 by using a charging roller rolling on the surface of the photosensitive member 10. The charging unit 20 may be of a contact charging type, which charges the photosensitive member 10 using a brush, or of a non-contact charging type, which charges the photosensitive member 10 by using corona discharge.

The exposure unit 30 (30K to 30C) irradiates the surface of the photosensitive member 10, charged by the charging unit 20, with light according to image data to form an electrostatic latent image having a latent image potential on the basis of the potential difference. This electrostatic latent image is moved to the position where the developing unit 40 is disposed, in accordance with the rotation of the photosensitive member 10.

The developing unit 40 (40K to 40C) includes a developing roller 41 (41K to 41C). Toner attracted to this developing roller 41 is transferred to the photosensitive member 10. In other words, due to the potential difference between the electrostatic latent image formed on the photosensitive member 10 and the charged toner, the toner moves to the surface of the photosensitive member 10. In this manner, the toner image is formed on the photosensitive member 10, and the toner image is moved to the position where the transfer unit 50 is disposed, in accordance with the rotation of the photosensitive member 10.

The transfer unit 50 includes an intermediate transfer belt 51, a back-up roller 52, support rollers 53, first transfer rollers 54 (54K to 54C), and a second transfer roller 55. A sheet P is transported by transport rollers 91 to the transfer unit 50, where a toner image on the intermediate transfer belt 51 is transferred to the sheet P. Then, this sheet P is transported to the fixing unit 70.

The intermediate transfer belt 51 is looped around the support rollers 53 and the back-up roller 52 and is driven by, for example, one of the support rollers 53. The first transfer rollers 54 are provided so as to face the corresponding photosensitive members 10 with the intermediate transfer belt 51 therebetween. The first transfer roller 54K faces the photosensitive member 10K, and the other transfer rollers face the corresponding photosensitive members.

The first transfer rollers 54K to 54C are rotated by the running intermediate transfer belt 51 and press the intermediate transfer belt 51 while they are rotated. The toner images formed on the photosensitive members 10K to 10C are transferred to the surface of the intermediate transfer belt 51 in an overlapping manner. The second transfer roller 55 is provided so as to face the back-up roller 52. The intermediate transfer belt 51 and the sheet P are nipped between the second transfer roller 55 and the back-up roller 52, and the toner image on the intermediate transfer belt 51 is transferred to the sheet P.

The transport device 60 transports the sheet P having the toner image transferred thereto in the transfer unit 50 to the fixing unit 70. The transport device 60 according to the exemplary embodiment will be described below.

The fixing unit 70 includes a fixing roller 71 having a heat source, and a pressure roller 72 provided so as to face the fixing roller 71. The fixing unit 70 applies heat and pressure to fix the unfixed toner image to the sheet P. The sheet P having the toner image fixed in the fixing unit 70 is transported by the transport rollers 91 and is then stored.

After the toner image is transferred to the sheet P, the cleaning unit 80 removes toner remaining on the surface of the photosensitive member 10. The sheet storage unit 81 accommodates multiple sheets P. A sheet P is picked from the sheet storage unit 81 by the sheet-feed roller 90 and is transported to the transfer unit 50 by the transport rollers 91.

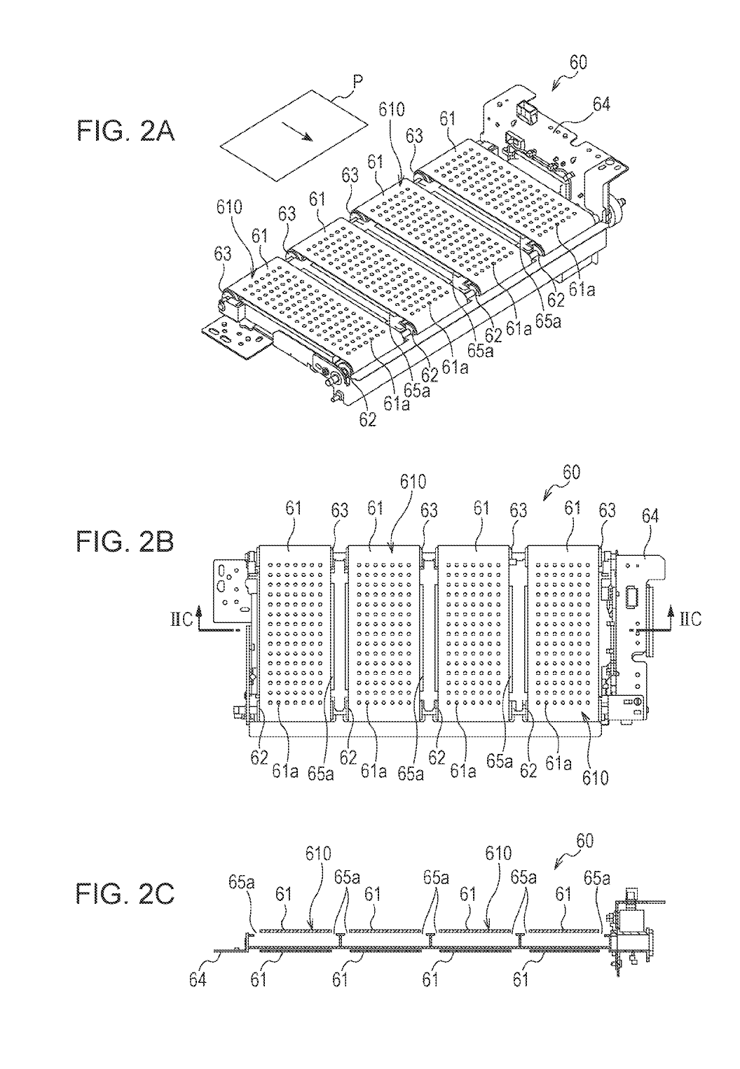

Next, the transport device 60 according to the exemplary embodiment will be described. FIGS. 2A to 2C are schematic vies of the transport device 60. FIG. 2A is a schematic perspective view, FIG. 2B is a schematic plan view, and FIG. 2C is a schematic cross-sectional view taken along line IIC-IIC in FIG. 2B. As illustrated in FIGS. 1 and 2A to 2C, the transport device 60 includes endless belts 61 having transport surfaces 610 provided with multiple holes 61a; driving rollers 62 and driven rollers 63, serving as stretching members, around which the endless belts 61 are looped so as to be able to revolve; a driving unit 62a that drives the driving rollers 62; a suction unit 64 provided inside the endless belts 61 to draw air A from the inside; a suction fan 65; and openings 65a provided above the suction unit 64. The driving unit 62a and the suction fan 65 are controlled by the controller 2.

The endless belts 61 convey the sheet P from the transfer unit 50 to the fixing unit 70. The endless belts 61 have multiple holes 61a in the transport surfaces 610 over which the sheet P is transferred. When the air A (not shown) is drawn through the holes 61a, the sheet P sticks to the transport surfaces 610 of the endless belts 61, enabling the sheet P to be stably transported.

As illustrated in FIGS. 2A to 2C, in the exemplary embodiment, four endless belts 61 are disposed parallel to the sheet transport direction. These endless belts 61 are made of, for example, ethylene propylene diene monomer (EPDM) rubber with carbon dispersed therein.

Corresponding to the four endless belts 61, four driving rollers 62 and four driven rollers 63 are provided. The endless belts 61 are looped around the driving rollers 62 and the driven rollers 63. The driving rollers 62 are driven by the driving unit 62a, such as a motor, causing the endless belts 61 to run in the sheet transport direction. The driven rollers 63 are rotated by the rotation of the endless belts 61.

As described above, the suction fan 65 is disposed inside the endless belts 61 to suck the air A. The suction fan 65 is provided, for example, at a side of the endless belts 61 arranged side-by-side and draws the air A from the inside of the endless belts 61 via the suction unit 64.

The suction unit 64 includes a lower part and an upper part that are made of, for example, sheet metal and resin, respectively. The driving rollers 62 and the driven rollers 63 are attached to the lower part, and the openings 65a are provided in the upper part.

The openings 65a are provided such that the sheet P sticks to the endless belts 61 via the multiple holes 61a. That is, the openings 65a are provided corresponding to the endless belts 61, such that the sheet P sticks to the endless belts 61 when the suction unit 64 draws the air.

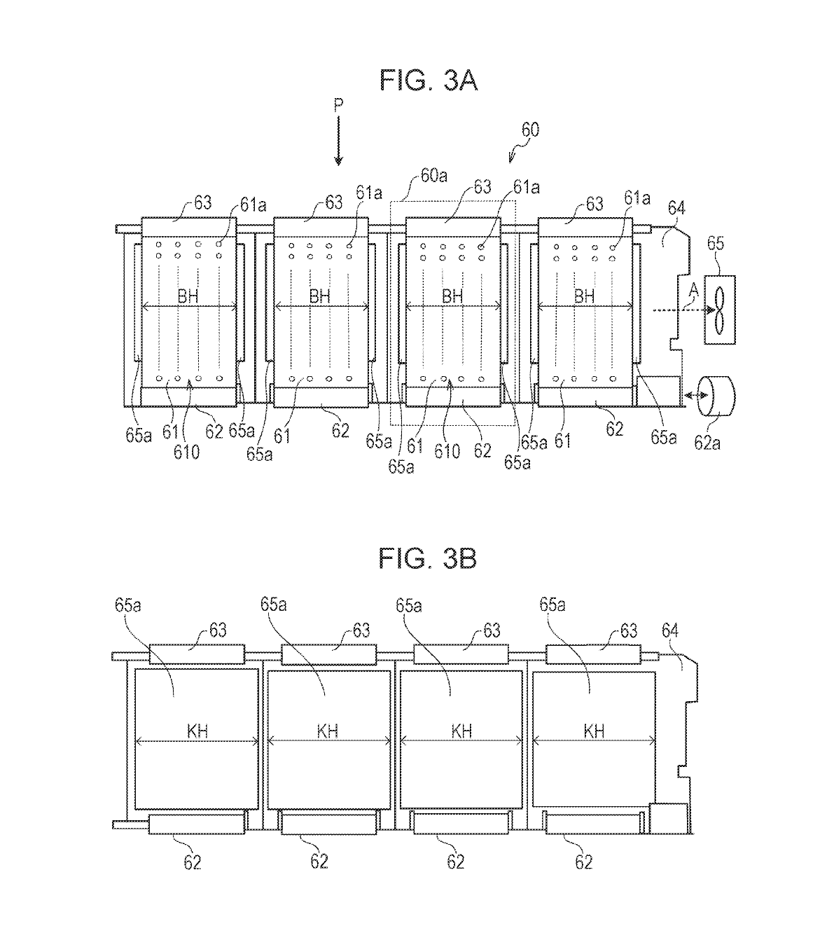

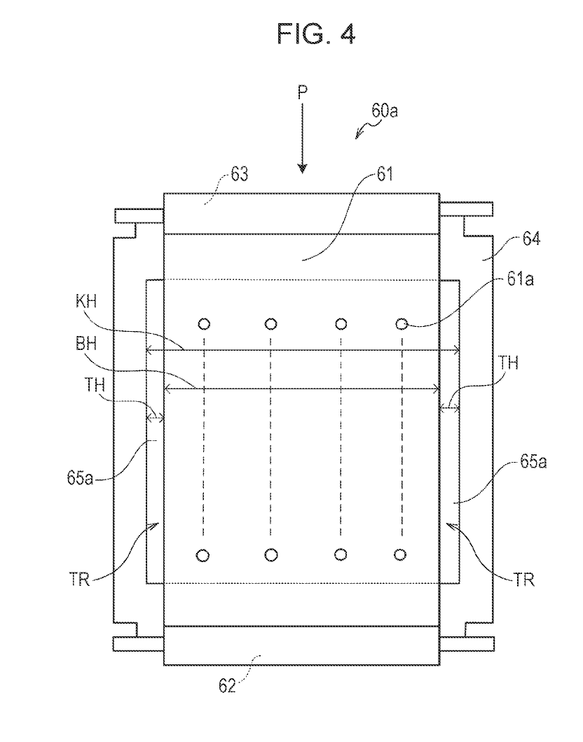

Next, referring to FIGS. 3A, 3B, and 4, the openings 65a will be described. FIG. 3A is a schematic view of the transport device 60 with the endless belts 61 being fitted to the suction unit 64, and FIG. 3B is a schematic view of the transport device 60 without the endless belts 61. The sheet P is transported in the direction indicated by the arrow P in FIG. 3A.

As illustrated in FIGS. 3A and 3B, the width, KH, of the openings 65a in the width direction of the endless belts 61 (hereinbelow, “opening width KH”) is larger than the width, BH, of the endless belts 61 (hereinbelow, “belt width BH”). That is, the opening width KH, illustrated in FIG. 3B, which is the width of the openings 65a in the direction perpendicular to the sheet transport direction is larger than the belt width BH of the endless belts 61, illustrated in FIG. 3A. In the transport device 60, the midpoint of the opening width KH and the midpoint of the belt width BH may be aligned.

FIG. 4 is an enlarged schematic view of a transport portion 60a, which is a part of the transport device 60, encircled by a dashed line in FIG. 3A. The sheet P is transported in the direction indicated by the arrow P in FIG. 4. As described above, the opening width KH is larger than the belt width BH. Hence, portions of the openings 65a at the sides of the endless belts 61 in the width direction are exposed. As illustrated in FIG. 4, the exposed portions of the openings 65a have a width TH (hereinbelow, “end width TH”). When the midpoint of the opening width KH and the midpoint of the belt width BH are aligned, the exposed portions at the sides of the belt have the same end width TH.

The end width TH is, for example, from 5 mm to 10 mm. With this end width TH, even when the endless belts 61 meanders, the endless belts 61 do not touch portions of the suction unit 64 at the sides of the openings 65a.

Furthermore, the amount of air A drawn by the suction unit 64 to suck the sheet P is set according to the opening area of end areas TR, which are the exposed portions of the openings 65a, having the end width TH illustrated in FIG. 4. For example, when the opening area is large, the amount of air A to be drawn is increased. Thus, an appropriate suction force is applied to the sheet P.

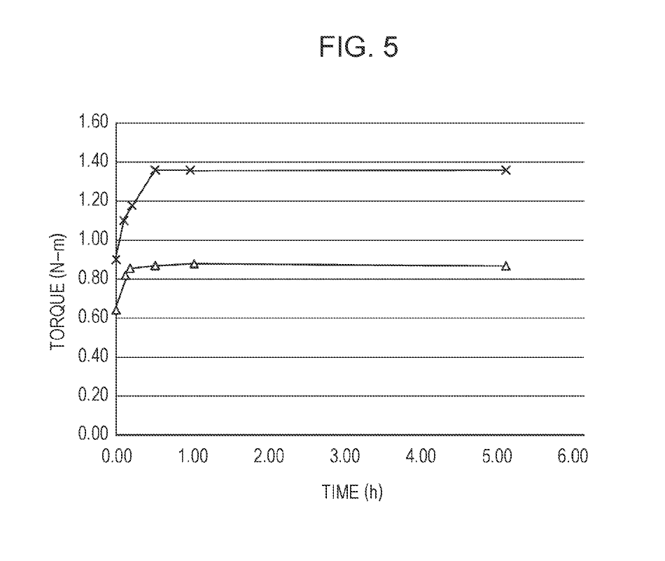

Next, the advantages of the transport device 60 according to the exemplary embodiment will be described using FIG. 5. The vertical axis in FIG. 5 indicates the load (N-m) on the driving unit 62a, and the horizontal axis indicates time. In FIG. 5, the line with triangle symbols shows the change in torque (load) of the driving unit 62a of the transport device 60 according to this exemplary embodiment with time, and the line with cross symbols shows the change in torque (load) of a driving unit for a transport device that does not have the end width TH, according to a reference example, with time. This graph shows the static torques of the driving unit 62a measured, while suction is performed by the transport device in the same way as the actual device, zero minute, five minutes, ten minutes, an hour, and five hours after the transport device is activated.

As illustrated in FIG. 5, in the transport device 60 according to the exemplary embodiment, the load on the driving unit 62a is at least 0.3 (N-m) lower than the reference example. Hence, in the transport device 60 and the image forming apparatus 1 having the same according to this exemplary embodiment, with a simple configuration in which the width of the openings 65a in the direction perpendicular to the transport direction is increased, the contact area between the ends of the endless belts 61 and the suction unit 64 is reduced, whereby the load on the driving unit 62a is reduced.

### Other Exemplary Embodiments

The transport device 60 and the image forming apparatus 1 having the same according to the exemplary embodiment have been described above. However, the present invention is not limited to the above-described exemplary embodiment, and other exemplary embodiments are also possible. The other exemplary embodiments will be described below.

Although the transport device according to the exemplary embodiment is formed of four endless belts, the configuration is not limited thereto. For example, in another exemplary embodiment, five endless belts may be used.

Although one transport device 60 is used in the exemplary embodiment, the configuration is not limited thereto. For example, in another exemplary embodiment, several transport devices 60 may be provided in the sheet transport direction.

Although the suction fan 65 is provided at a side of the endless belts 61 in the exemplary embodiment, the configuration is not limited thereto. For example, in another exemplary embodiment, the suction fan 65 may be provided below the endless belts 61.

Although the four endless belts 61 have the same end width TH in the exemplary embodiment, the configuration is not limited thereto. For example, in another exemplary embodiment, the end width TH may be increased in the middle of the transport device 60 in the width direction. Although the end width TH, which is the distance between the ends of the opening and the belt, of the transport device 60 according to the exemplary embodiment is from 5 mm to 10 mm, the configuration is not limited thereto. For example, in another exemplary embodiment, when the endless belts 61 run stably without meandering, the end width TH may be less than 5 mm, and when the distance between the endless belts 61 arranged side-by-side is large, the end width TH may be more than 10 mm.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transport device comprising:
an endless belt having a recording-medium transport surface provided with multiple holes;
stretching members between which the endless belt is stretched so as to be able to revolve; and
a suction unit provided inside the endless belt,
wherein the suction unit has an opening having a larger width than the endless belt,
wherein the opening is exposed at both sides of the endless belt in the width direction, and
wherein the suction unit draws air through the opening to cause the recording medium to stick to the endless belt.

2. The transport device according to claim 1,
wherein the exposed portions of the opening have a width of from 5 mm to 10 mm.

3. The transport device according to claim 1,
wherein a plurality of the endless belts and a plurality of the openings are arranged parallel to the recording-medium transport direction.

4. The transport device according to claim 1,
wherein the amount of air drawn to suck the recording medium is set according to the opening area of the opening.

5. An image forming apparatus comprising:
a photosensitive member;
a transfer unit that transfers a toner image formed by the photosensitive member to a recording medium;
a fixing unit that fixes the toner image to the recording medium; and
the transport device according to claim 1, which transports the recording medium from the transfer unit to the fixing unit.
